(19) United States
(12) Patent Application Publication
(10) Pub. No.: US 2007/0001933 A1
(43) Pub. Date: Jan. 4, 2007

(54) Device and method for driving display panel

(75) Inventors: Masahiro Suzuki, Yamanashi-ken (JP); Jun Kamiyamaguchi, Yamanashi-ken (JP); Tetsuya Shigeta, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/147,389

(22) Filed: Jun. 8, 2005

(30) Foreign Application Priority Data
Jun. 16, 2004 (JP) 2004-178653

(51) Int. Cl. G09G 3/28

(52) U.S. Cl. 345/63

(57) ABSTRACT

A device for driving a display panel, in which a predetermined number of continuous subfields in one field is each formed by M divided subfields and n display lines are divided into M display line groups for each display lines, data conversion is applied to pixel data corresponding to each of the M display line groups with a different conversion characteristic from each other, multi-gradation processing is applied to the pixel data subjected to the data conversion, and address scanning for changing each of the pixel cells from the lit mode to the unlit mode in accordance with the pixel data subjected to the multi-gradation processing is performed for each of the display line groups in each of the M divided subfields.

### BACKGROUND OF THE INVENTION

1. Field of the Invention

The present invention relates to a drive device and a drive method for driving a display panel such as a plasma display panel.

2. Description of the Related Art

Recently, as a two-dimensional image display panel that is a thin type and lightweight, a plasma display panel (hereinafter referred to as a PDP) has received attention. The PDP is directly driven by a digital video signal, and gray scale of luminance which the PDP can represent is determined by bit number of pixel data of each pixel on the basis of the above digital video signal.

As a method of gradation-driving the PDP, a subfield method has been known, in which a unit frame display period, for example, one field (one frame) display period is divided into subfields of N-number, of which each emits light for only time corresponding to a weight of each bit digit of pixel data (N bits), thereby to drive the PDP. Herein, the field takes a video signal of interlaced type such as NTSC into consideration, and in a video signal of non-interlaced type, the field corresponds to a frame.

For example, in the case that pixel data is 8 bits, one filed display period is divided into 8 subfields comprising subfields SF8, SF7, . . . , SF1 in order of a weight. Each of the subfields has an address period in which setting of a lit pixel and a unlit pixel according to pixel data is performed for each display line of the PDP, and a sustain period in which only the lit pixel is caused to emit light for only time corresponding to a weight of its subfield. Namely, in each of the subfields, light-emission drive control determining whether light emission is executed or not in its subfield is individually performed. Therefore, in one field, subfields in a “light emission state” and subfields in a “non-light emission state” are mixed. At this time, by total time of light emission executed in each subfield in one filed, a halftone luminance is represented.

In a display apparatus adopting the PDP, the gradation drive uses dither processing together, thereby to increase the gray scale visually and improve image quality.

In the dither processing, by a plurality of pixels on a display screen which are adjacent to each other, one halftone luminance is represented. For example, with four pixels adjacent to each other up and down and right and left forming a set, four dither values (for example, 0, 1, 2, and 3) composed of values (added value) different to each other are assigned to pixel data corresponding to each of this set of pixels, and added to each pixel data.

When an image subjected to the dither processing is a still image, the image is as clear as an original image because of an integral effect of eyes. The image is shown as a high quality image. However, in the case of a moving image, noise (pattern) peculiar to dither tends to be conspicuous because eyes follow movement of the image. Thus, in order to control the sense of noise, a four-line dither sequence has been proposed. In the four-line dither sequence, a plurality of display lines are divided into M display line groups and each subfield is divided into M in association with each of the display line groups. For each of the divided subfields, address scanning for each of the display line groups is performed.

However, in the four-line dither sequence, since a luminance difference for the same gradation occurs among the display line groups. Therefore, in the dither processing, even if line offset data for each of the display line groups is added other than dither values in order to compensate for the luminance difference, linearity of luminance is deteriorated in general input/output characteristics.

### SUMMARY OF THE INVENTION

It is an object of the invention to provide a device and a method for driving a display panel that can improve general linearity of light emission luminance with respect to input data in the case in which a line dither sequence is used.

A display panel driving device according to the invention is a device for driving a display panel which has n (n is a natural number) display lines and pixel cells carrying pixels for each of the n display lines, and in order to display a halftone image in a one-field display period of a video signal which is divided into the plurality of sub-fields, for performing address scanning for changing each of the pixel cells from a lit mode to an unlit mode in one of the plurality of subfields in accordance with image data based on the video signal, a predetermined number of continuous subfields in one field each being formed by M divided subfields and the n display lines being divided into M display line groups for each display lines, the device comprising: a data converter which applies data conversion to pixel data corresponding to each of the M display line groups with a different conversion characteristic from each other; a multi-gradation processing unit which applies multi-gradation processing to the pixel data subjected to the data conversion; and a gradation drive unit which performs the address scanning for changing each of the pixel cells from the lit mode to the unlit mode in accordance with the pixel data subjected to the multi-gradation processing for each of the display line groups in each of the M divided subfields.

A display panel driving method according to the invention is a method for driving a display panel which has n (n is a natural number) display lines and pixel cells carrying pixels for each of the n display lines, and in order to display a halftone image in a one-field display period of a video signal which is divided into the plurality of sub-fields, for performing address scanning for changing each of the pixel cells from a lit mode to an unlit mode in one of the plurality of subfields in accordance with image data based on the video signal, a predetermined number of continuous subfields in one field each being formed by M divided subfields and the n display lines being divided into M display line groups for each display lines, the method comprising: a step of applying data conversion to pixel data corresponding to each of the M display line groups with a different conversion characteristic from each other; a step of applying multi-gradation processing to the pixel data subjected to the data conversion; and a step of performing the address scanning for changing each of the pixel cells from the lit mode to the unlit mode in accordance with the pixel data subjected to the multi-gradation processing for each of the display line groups in each of the M divided subfields.

A display panel driving device according to the invention is a device for driving a display panel which has a plurality of display lines and pixel cells carrying pixels for each of the plurality of display lines, so as to display a halftone image in accordance with image data based on the video signal, the device comprising: a data converting unit which applies, for each display line group including p (p is a natural number equal to or larger than two) display lines adjacent to one another, data conversion to pixel data corresponding to each of the p display lines with a different conversion characteristic from each other for each of the display lines; a multi-gradation processing unit which applies multi-gradation processing to the pixel data subjected to the data conversion; and a light emission driver which allows the pixel cells to emit light in accordance with the pixel data subjected to the multi-gradation processing with a luminance weight different from each other given to each of the display line groups.

A display panel driving method according to the invention is a method for driving a display panel which has a plurality of display lines and pixel cells carrying pixels for each of the plurality of display lines, so as to display a halftone image in accordance with image data based on the video signal, the method comprising: a step of applying, for each display line group including p (p is a natural number equal to or larger than two) display lines adjacent to one another, data conversion to pixel data corresponding to each of the p display lines with a different conversion characteristic from each other for each of the display lines; a step of applying multi-gradation processing to the pixel data subjected to the data conversion; and a step of allowing the pixel cells to emit light in accordance with the pixel data subjected to the multi-gradation processing with a luminance weight different from each other given to each of the display line groups.

### BRIEF DESCRIPTION OF THE DRAWINGS

FIG. 1 is a diagram showing a schematic structure of a plasma display apparatus to which the invention is applied;

FIG. 2 is a block diagram showing an internal structure of a data conversion circuit;

FIG. 3 is a graph showing first to fourth data conversion characteristics;

FIG. 4 is a block diagram showing an internal structure of a multi-gradation processing circuit;

FIG. 5 is a diagram showing an SF conversion table and a light emission drive pattern;

FIG. 6 is a diagram showing a light emission drive format of the plasma display apparatus in FIG. 1;

FIG. 7 is a graph showing light emission luminance characteristics with respect to pixel data after first to fourth data conversions;

FIG. 8 is a graph showing a general input/output characteristic of light emission luminance with respect to pixel data; and

FIG. 9 is a graph showing an error characteristic with respect to an ideal input/output characteristic.

### DETAILED DESCRIPTION OF THE INVENTION

An embodiment of the present invention will be hereinafter explained in detail with reference to the accompanying drawings.

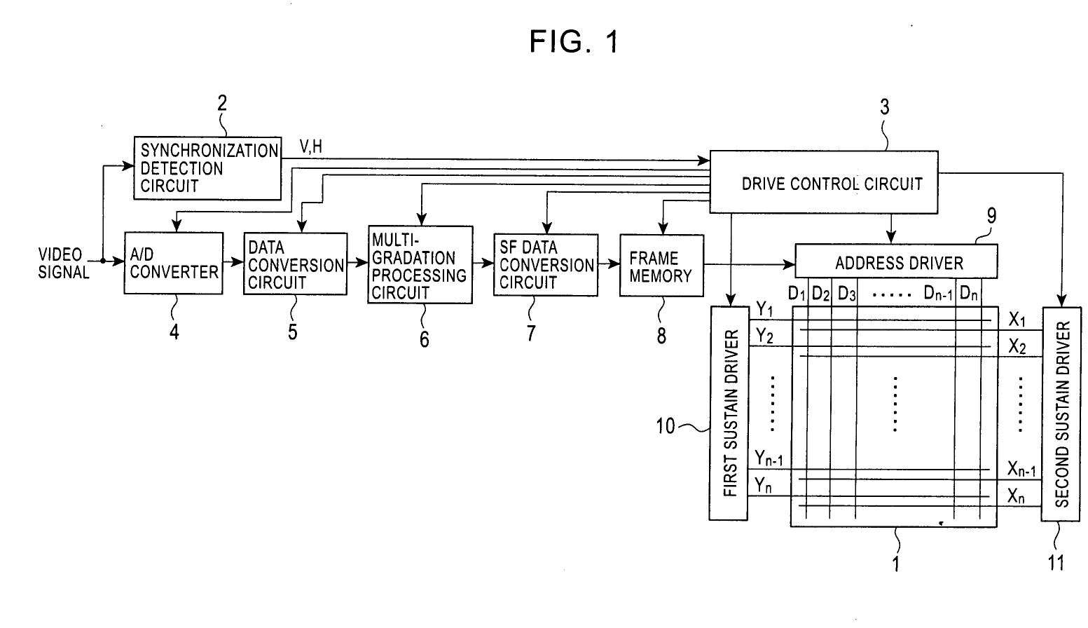

FIG. 1 shows a schematic structure of a plasma display apparatus according to the present invention.

The plasma display apparatus has a PDP 1 serving as a plasma display panel. The plasma display apparatus includes a synchronization detection circuit 2, a drive control circuit 3, an A/D converter 4, a data conversion circuit 5, a multi-gradation processing circuit 6, an SF data conversion circuit 7, a frame memory 8, an address driver 9, a first sustain driver 10, and a second sustain driver 11 that are used for driving the PDP 1.

The PDP 1 includes column electrodes D₁ to Dₘ serving as address electrodes and row electrodes X₁ to Xₙ and row electrodes Y₁ to Yₙ that are arranged orthogonal to the column electrodes. In the PDP 1, a pair of the row electrode X and the row Y forms a row electrode corresponding to an electrode for one row. The row electrode pairs and the column electrodes are covered by a dielectric layer against a discharge space. Discharge cells corresponding to pixels are formed at intersections of the respective row electrode pairs and the respective column electrodes. In the PDP 1, n×m pixels corresponding to the first row/the first column to the nth row/the mth column, respectively, are formed.

N display lines form four display line groups. A first display line group includes a 4k-3rd line, a second display line group includes a 4k-2nd line, a third display line group includes a 4k-1st line, and a fourth display line group includes a 4kth line. K is an integer equal to or larger than 1.

The synchronization detection circuit 2 generates a vertical synchronization signal V when the synchronization detection circuit 2 detects a vertical synchronization signal V out of video signals serving as unit frame information signals that are continuously supplied for each frame. Moreover, the synchronization detection circuit 2 generates a horizontal synchronization signal H when the synchronization detection circuit 2 detects a horizontal synchronization signal H out of the video signals. The synchronization detection circuit 2 supplies the vertical synchronization signal V and the horizontal synchronization signal H to the drive control circuit 3 and the data conversion circuit 5. The A/D converter 4 samples a video signal out of the video signals in accordance with a clock signal supplied from the drive control circuit 3, converts the video signal into 8-bit pixel data D indicating luminance from “0” to “255” for each pixel, and supplies the pixel data D to the data conversion circuit 5.

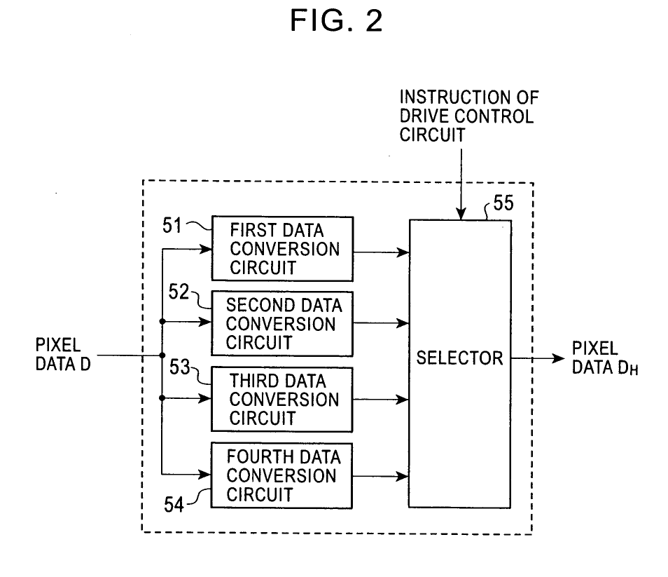

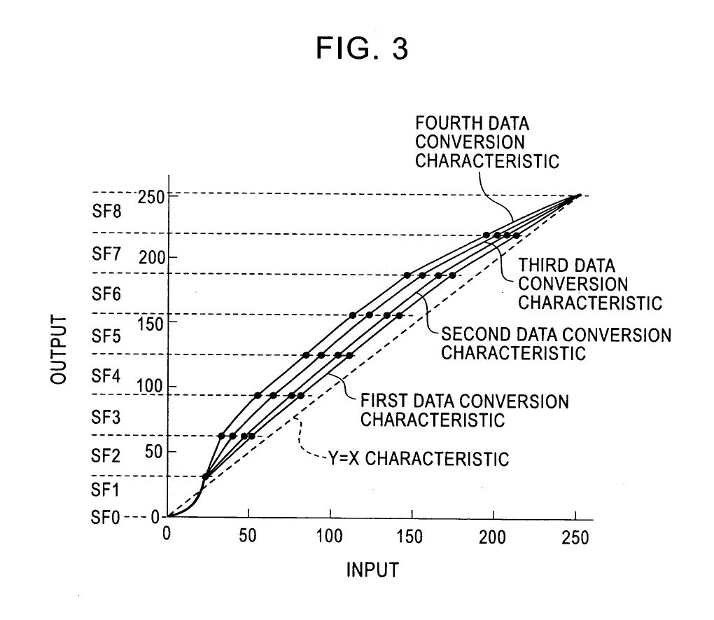

As shown in FIG. 2, the data conversion circuit 5 includes first to fourth data conversion circuits 51 to 54 and a selector 55. The pixel data D is supplied to the first to the fourth data conversion circuits 51 to 54. As shown in FIG. 3, the first to the fourth data conversion circuits 51 to 54 have conversion characteristics different from one another. The first to the fourth data conversion circuits 51 to 54 converts the pixel data D into 8-bit converted pixel data D_{H} from “0” to “255”. The first data conversion circuit 51 is a data conversion circuit for the first display line group 4k-3, the second data conversion circuit 52 is a data conversion circuit for the second display line group 4k-2, the third data conversion circuit 53 is a data conversion circuit for the third display line group 4k-1, and the fourth data conversion circuit 54 is a data conversion circuit for the fourth display line group 4k.

Conversion characteristics of the first to the fourth data conversion circuits 51 to 54 are determined taking into account actual visual characteristics. The first to the fourth data conversion circuits 51 to 54 have characteristics obtained by subjecting a signal between subfields described later to gamma correction (raising subfields to the power of 2.2). A relation between an input value x and an output value y of the first to the fourth data conversion circuits 51 to 54 can be represented by the following expression. When xi≦x≦xi+1,
y={(x^{γ}−xᵢ^{γ})×(yᵢ₊₁−yᵢ)/(xᵢ₊₁^{γ}−xᵢ^{γ})}+yᵢ
Note that γ is a gamma value and i is 0, 1, 2, and so on.

The selector 55 selects and outputs one output data of the output pixel data DH of the first to the fourth data conversion circuits 51 to 54 in accordance with an instruction of the drive control circuit 3. Data conversion complying with the number of display gradations in the multi-gradation processing circuit 6 and the number of compressed bits, which are obtained by the multi-gradation, is performed by the data conversion circuit 5. This prevents luminance saturation due to multi-gradation processing of the multi-gradation processing circuit 6 and occurrence of a flat portion of a display characteristic (i.e., occurrence of gradation distortion) that is caused when display gradation is not in a bit boundary.

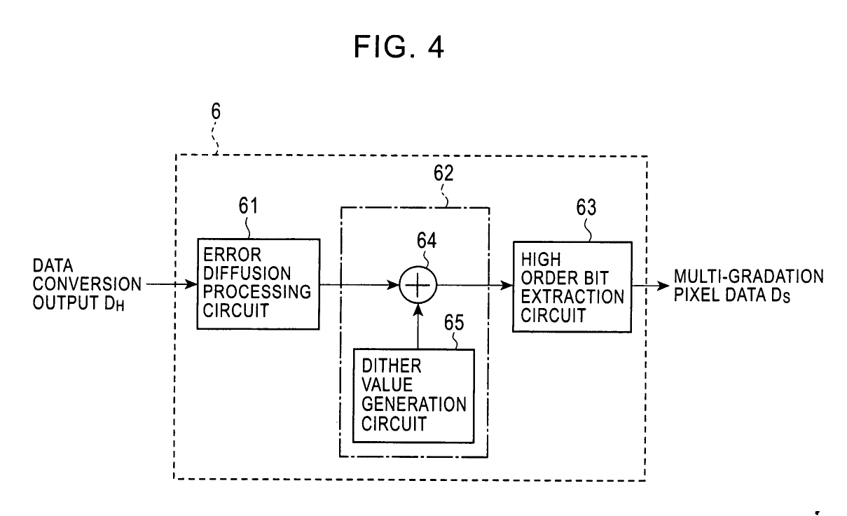

As shown in FIG. 4, the multi-gradation processing circuit 6 includes an error diffusion processing circuit 61, a dither processing circuit 62, and a high order bit extraction circuit 63. The dither processing circuit 62 includes an adder 64 and a dither value generation circuit 65.

The multi-gradation processing circuit 6 applies error diffusion processing and dither processing to the 8-bit converted pixel data D_{H} to thereby generate multi-gradation processing pixel data D_{S} obtained by reducing the number of bits to three while maintaining the number of gradations. First, the error diffusion processing circuit 61 recognizes a high order six bits of the pixel data D_{H} as display data and recognizes the remaining low order two bits of the pixel data D_{H} as error data. Then, the error diffusion processing circuit 61 reflects error data, which is obtained by weighting and adding respective error data of the pixel data D_{H} corresponding to respective peripheral pixels, on the display data. Through such an operation, luminance for the lower two bits in the original pixels is represented simulatively by the peripheral pixels. This makes it possible to represent, with display data for six bits smaller than eight bits, a luminance gradation equivalent to that of the pixel data for eight bits. The multi-gradation processing circuit 6 applies the dither processing to 6-bit error diffusion processing pixel data obtained by the error diffusion processing. In the dither processing circuit 62, with plural pixels adjacent to one another set as one pixel group, the dither value generation circuit 65 generates dither values different from each other for the respective error diffusion processing pixel data corresponding to the respective pixels in this one pixel group. The adder 64 adds the dither values and the error diffusion processing pixel data to obtain dither added pixel data. According to the addition of dither values, when the one pixel group is viewed, it is possible to represent luminance equivalent to eight bits only with high order three bits of the dither added pixel data. Thus, the high order bit extraction circuit 63 supplies the high order three bits of the dither added pixel data to the SF data conversion circuit 7 as the multi-gradation pixel data D_{S}.

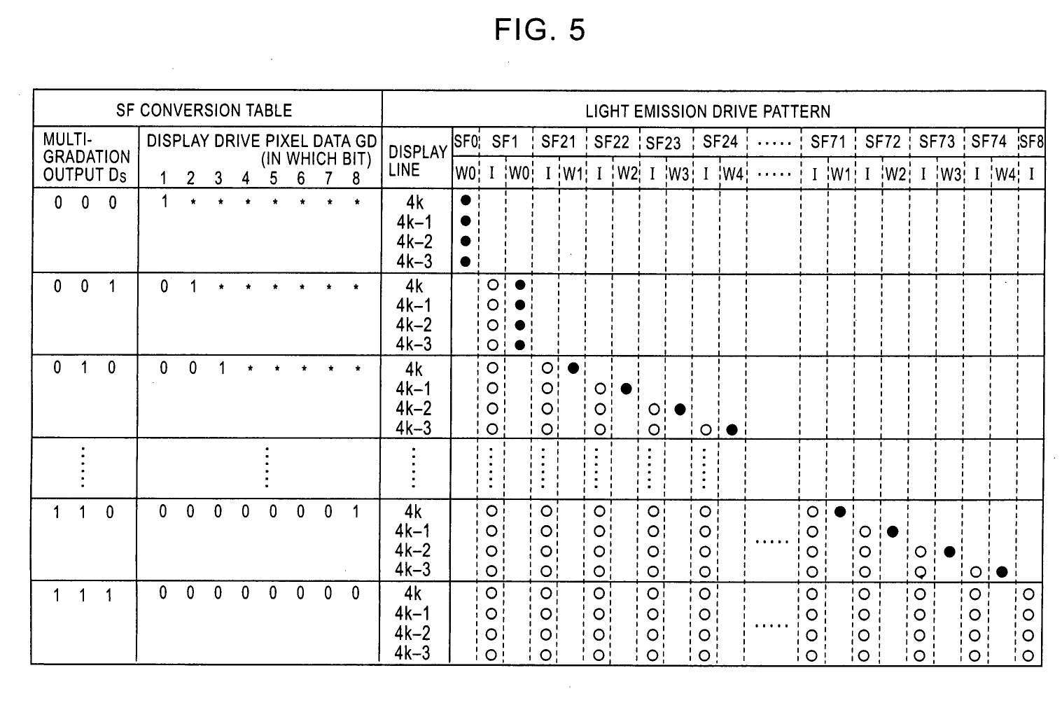

The SF data conversion circuit 7 converts the multi-gradation pixel data D_{S} for the high order three bits into display drive pixel data GD consisting of eight bits in accordance with a conversion table shown in FIG. 5. The respective eight bits correspond to subfields SF0 to SF7 described later in order of bit.

The frame memory 8 sequentially writes and stores the display drive pixel data GD therein in accordance with a writing signal supplied from the drive control circuit 3. According to the writing operation, GD₁₁ to GDₙₘ are written as display drive pixel data for one frame (n rows and m columns). When the writing ends, the frame memory 8 sequentially reads out the display drive pixel data GD₁₁ to GDₙₘ for the same bit digit and for each row in accordance with a readout signal supplied from the drive control circuit 3 and supplies the display drive pixel data GD₁₁ to GDₙₘ to the address driver 9. In other words, the frame memory 8 reads out the display drive pixel data GD₁₁ to GDₙₘ for one frame, each consisting of eight bits, as display drive pixel data bits DB1₁₁ to DB8ₙₘ that are obtained by dividing the display drive pixel data GD₁₁ to GDₙₘ into eight in the following manner.

DB1₁₁ to DB1ₙₘ: first bit of the display drive pixel data GD₁₁ to GDₙₘ

DB2₁₁ to DB2ₙₘ: second bit of the display drive pixel data GD₁₁ to GDₙₘ

DB3₁₁ to DB3ₙₘ: third bit of the display drive pixel data GD₁₁ to GDₙₘ

DB4₁₁ to DB4ₙₘ: fourth bit of the display drive pixel data GD₁₁ to GDₙₘ

DB5₁₁ to DB5ₙₘ: fifth bit of the display drive pixel data GD₁₁ to GDₙₘ

DB6₁₁ to DB6ₙₘ: sixth bit of the display drive pixel data GD₁₁ to GDₙₘ

DB7₁₁ to DB7ₙₘ: seventh bit of the display drive pixel data GD₁₁ to GDₙₘ

DB8₁₁ to DB8ₙₘ: eighth bit of the display drive pixel data GD₁₁ to GDₙₘ

These display drive pixel data bits DB1₁₁ to DB1ₙₘ, DB2₁₁ to DB2ₙₘ, . . . , DB8₁₁ to DB8ₙₘ are sequentially read out for each row in accordance with a readout signal supplied from the drive control circuit 3 and supplied to the address driver 9.

The drive control circuit 3 generates a clock signal to be supplied to the A/D converter 4 and writing and readout signals to be supplied to the frame memory 8 in synchronization with the horizontal synchronization signal H and the vertical synchronization signal V.

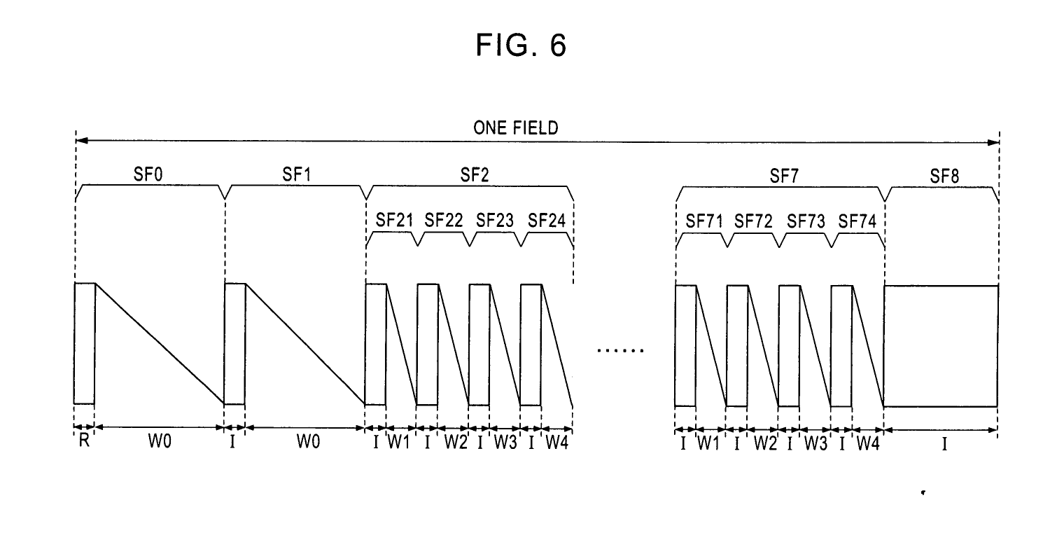

The drive control circuit 3 supplies various timing signals for driving the PDP 1 to the address driver 9, the first sustain driver 10, and the second sustain driver 11 in accordance with a light emission drive format shown in FIG. 6.

In a light emission drive sequence shown in FIG. 6, a display period for one field is divided into subfields SF0 to SF8. As shown in FIG. 6, the subfields SF2 to SF7 include four subfields SF21 to SF24, SF31 to SF34, . . . , SF71 to SF74, respectively. Various drive steps are carried out for each of the subfields as described below.

First, in the top subfield SF0, a reset step R of initializing all discharge cells of the PDP 1 to a lit mode (a state in which a predetermined amount of wall charge is formed) is executed. After the reset step R ends, address step W0 of changing the respective discharge cells to an unlit mode (a state in which a wall charge is erased) selectively is executed on all display lines in accordance with the pixel drive data.

In the subfield SF1, as a result of the address step W0 in the subfield SF0, a sustain step I of causing only the discharge cells in the lit mode to discharge and emit light is executed. After the sustain step I ends, an address step W0 of changing the respective discharge cells to the unlit mode selectively is executed on all the display lines in accordance with the pixel drive data.

In the subfield SF21, the sustain step I of causing only the discharge cells in the lit mode to discharge and emit light is executed in accordance with a result of the address step W0 in the subfield SF1. After the sustain step I ends, an address step W1 of changing the respective discharge cells, which belong to the 4kth display line, to the unlit mode selectively is executed in accordance with pixel drive data.

In the subfield SF22, the sustain step I of causing only the discharge cells in the lit mode is executed in accordance with results of the address step W1 in the subfield SF21 for the 4kth display line and the address step W0 of the subfield SF1 for the other display lines. After the sustain step I ends, an address step W2 for changing the respective discharge cells, which belong to the 4k-1st display line, to the unlit mode selectively is executed in accordance with pixel drive data.

In a subfield SF23, the sustain step I of causing only the discharge cells in the lit mode to discharge and emit light is executed in accordance with results of the address step W2 in the subfield SF22 for the 4k-1st display line, the address step W1 in the subfield SF21 for the 4kth display line, and the address step W0 in the subfield SF1 for the 4k-2nd and 4k-3rd display lines. After the sustain step I ends, an address step W3 of changing the respective discharge cells, which belong to the 4k-2nd display line, to the unlit mode selectively is executed in accordance with pixel drive data.

In the subfield SF24, the sustain step I of causing only the discharge cells in the lit mode to discharge and emit light is executed in accordance with results of the address step W3 in the subfield SF22 for the 4k-2nd display line, the address step W2 in the subfield SF22 for the 4k-1st display line, the address step W1 in the subfield SF21 for the 4kth display line, and the address step W0 in the subfield SF1 for the 4k-3rd display line. After the sustain step I ends, an address step W4 of changing the respective discharge cells, which belong to the 4k-3rd display line, to the unlit mode selectively is executed in accordance with pixel drive data.

In the sub-field SF31, the sustain step I of causing only the discharge cells in the lit mode to discharge and emit light is executed in accordance with results of the address steps W1 to W4 in the subfields SF21 to SF24. After the sustain step I ends, an address step W1 of changing the respective discharge cells, which belong to the 4kth display line, to the unlit mode selectively is executed in accordance with pixel drive data.

After that, the sustain step I and the address step W2, which are the same as those in the subfield SF22, are executed for the subfields SF32, SF42, . . . , and SF72. The sustain step I and the address step W3, which are the same as those in the subfield SF23, are executed for the subfields SF33, SF43, . . . , and SF73. The sustain step I and the address step W4, which are the same as those in the subfield SF24, are executed for the subfields SF34, SF44, . . . , and SF74. The sustain step I and the address step W1, which are the same as those in the subfield SF31, are executed for the subfields SF41, . . . , and SF71.

In the last subfield SF8 in one field, the sustain step I of causing only the discharge cells in the lit mode to discharge and emit light is executed in accordance with results of the address steps W1 to W4 in the subfields SF71 to SF74.

The address drive 9, the first sustain driver 10, and the second sustain driver 11 apply drive pulses such as a reset pulse, a scanning pulse, a data pulse, and a sustain pulse to the row electrodes and the column electrodes of the PDP 1 according to the control of the drive control circuit 3 complying with the light emission drive format.

In the reset step R, the first sustain driver 10 applies a reset pulse RP_{X} to the row electrodes X₁ to Xₙ. Simultaneously with the application of the reset pulse RP_{X}, the second sustain driver 11 applies a reset pulse RP_{Y} to the row electrodes Y₁ to Y₂. All the discharge cells are reset to discharge in accordance with the application of the reset pulses RP_{X} and RP_{Y} and a predetermined amount of wall charge is uniformly formed in the respective discharge cells. As a result, all discharge cells are set as the “light emitting cells” once.

In the address steps W0 and W1 to W4, the address driver 9 generates a pixel data pulse having a voltage corresponding to a logical level of a display drive pixel data bit DB supplied from the frame memory 8. In this case, the address driver 9 applies a pixel data pulse group DP including pixel data pulses for one row to the column electrodes D₁ to Dₘ. The second sustain driver 11 generates a scanning pulse SP at identical timing with application timing of the pixel data pulse group DP and sequentially applies the scanning pulse SP to the row electrodes Y₁ to Yₙ. In this case, discharge (selective erase discharge) occurs only in the discharge cells at intersections of the “rows” to which the scanning pulse SP is applied and the “columns” to which a high-voltage pixel data pulse is applied. The wall charge remaining in the discharge cells is selectively erased. The discharge cells initialized to the state of “light emitting cells” in the reset step R transition to “non-light emitting cells” because of the selective erase discharge. On the other hand, discharge is not caused in the discharge cells formed in the “columns”, to which a low-voltage pixel data pulse is applied, and the present state is maintained. In other words, the discharge cells serving as the “non-light emitting cells” maintain the state of the “non-light emitting cells” and the discharge cells serving as the “light emitting cells” maintain the state of the “light emitting cells”. In this way, according to the address steps W0 and W1 to W4 for each subfield, the “light emitting cells”, in which maintained discharge is caused, and the “non-light emitting cells”, in which maintained discharge is not caused, are set in the sustain step I immediately after the address steps.

In the sustain step I in the respective subfields, the first sustain driver 10 and the second sustain driver 11 apply maintenance pulses IP_{X} and IP_{Y} to the row electrodes X₁ to Xₙ and Y₁ to Yₙ alternately. The number of times of application of maintenance pulses IP is the number of times corresponding to luminance weighting for each of the subfields SF1 to SF8. Sustain discharge is caused by the application of the maintenance pulses IP_{X} and IP_{Y} to maintain a light emitting state following this discharge.

Only the discharge cells set as the “light emitting cells” in the address step W in the respective subfields repeat light emission in the sustain step I immediately after the address step W. In this case, luminance of a halftone is represented by a total number of times of light emission carried out in the respective subfields SF1 to SF8 in one field.

The display drive pixel data GD shown in FIG. 5 determines whether each of the discharge cells is set as the “light emitting cell” or the “non-light emitting cell”. When logical level of each bit of the display drive pixel data GD is “1”, selective erase discharge is caused in the address step W in a subfield corresponding to a bit digit of the bit and the discharge cell is set as the “non-light emitting cell”. On the other hand, when a logical level of the bit is “0”, since the selective erase discharge is not caused, the present state is maintained. In other words, the discharge cells serving as the “non-light emitting cells” are maintained as the “non-light emitting cells” and the discharge cells serving as the “light emitting cells” are maintained as the “light emitting cells”. In this case, an opportunity for making it possible to transition the discharge cells from the “non-light emitting cells” to the “light emitting cells” in the subfields SF0, SF1, SF21, . . . , and SF74 is in only the reset step R in the top subfield SF1. In other words, the discharge cells, which have changed to the “non-light emitting cells” once in the address step in one of the subfields SF0, SF1, SF21, . . . , and SF74, never transition to the “light emitting cells” again in the subfield after the end of the reset step R. Therefore, according to the display drive pixel data GD shown in FIG. 5, the respective discharge cells change to the “light emitting cells” in a period until selective erase discharge is caused in subfields indicated by black circles in FIG. 5. The discharge cells perform light emission by the number of times described above in the sustain step I in the respective subfields indicted by white circles present in the period.

The pixel data D, which is obtained on the basis of an input video signal, can represent halftones of eight bits, that is, 256 stages. Thus, the multi-gradation processing by the multi-gradation processing circuit 6 is carried out to realize halftone display near the 256 stages simulatively by the gradation drive in thirteen stages.

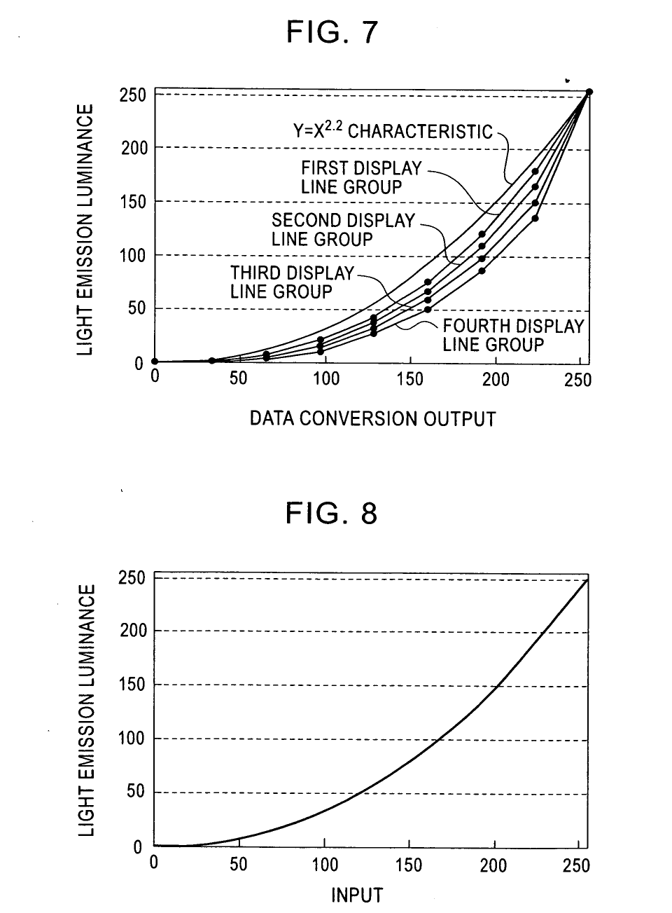

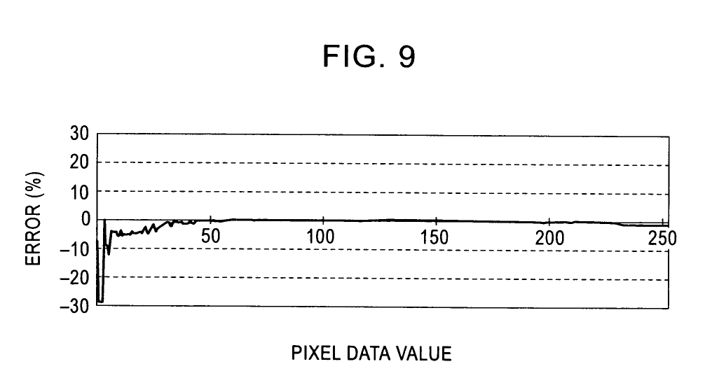

In the plasma display apparatus according to the invention, as shown in FIG. 7, it is possible to obtain light emission luminance with respect to pixel data “0” to “255” after data conversion by the data conversion circuit 5 in the first to the fourth display line groups. This is a characteristic of a drive section including the address driver 9, the first sustain driver 10, and the second sustain driver 11 because the plasma display apparatus has a linear characteristic in the processing in the error diffusion processing circuit 61 and the dither processing circuit 62. On the other hand, as described above, the plasma display apparatus has a different conversion characteristic for each of the display line groups because of the data conversion circuit 5. Thus, light emission luminance with respect to data inputted to the data conversion circuit 5, that is, a general input/output characteristic is obtained as shown in FIG. 8. As a result, as shown in FIG. 9, it is possible to obtain a characteristic substantially equal to an ideal input/output characteristic Y=X^{2.2}.

In the explanation of the embodiment described above, the invention is applied to the plasma display apparatus. However, the invention may be applied to other display apparatuses such as a liquid crystal display apparatus.

Although the four-line dither sequence is explained in the embodiment, the number of lines M and the number of adjacent lines p are not limited to four. The invention may be applied to a dither sequence with the number of lines such as eight.

In the explanation of the embodiment, as the drive method for subjecting the PDP 1 to gradation drive, a so-called selective writing address method is adopted. In the selective writing address method, all display cells are initialized such that a potential between row electrodes forming a pair caused by a wall charge is less than a predetermined value (the reset step R). A wall charge is formed in the display cells selectively on the basis of an input video signal. In other words, a wall charge is formed such that a potential between row electrodes forming a pair is equal to or higher than the predetermined value (the address step W). However, as the drive method for subjecting the PDP 1 to gradation drive, a so-called selective erase address method may be adopted. In the selective erase address method, wall charges are formed in all display cells. In other words, a wall charge is formed such that a potential between row electrodes forming a pair is equal to or higher than a predetermined value (the reset step R). The wall charges formed in the respective cells are erased selectively in accordance with pixel data. In other words, the wall charges are erased such that a potential between row electrodes forming a pair due to a wall charge is less than the predetermined value (the address step W).

As described above, according to the present invention, the drive device for driving a display panel includes the data converting means that applies data conversion to pixel data corresponding to the respective M display line groups with conversion characteristics different from one another. Thus, it is possible to improve general linearity of light emission luminance with respect to input data.

This application is based on Japanese Patent Application No. 2004-178653 which is hereby incorporated by reference.

What is claimed is:

1. A device for driving a display panel which has n (n is a natural number) display lines and pixel cells carrying pixels for each of the n display lines, and in order to display a halftone image in a one-field display period of a video signal which is divided into the plurality of sub-fields, for performing address scanning for changing each of the pixel cells from a lit mode to an unlit mode in one of the plurality of subfields in accordance with image data based on the video signal,
a predetermined number of continuous subfields in one field each being formed by M divided subfields and the n display lines being divided into M display line groups for each display lines,
said device comprising:
a data converter which applies data conversion to pixel data corresponding to each of the M display line groups with a different conversion characteristic from each other;
a multi-gradation processing unit which applies multi-gradation processing to the pixel data subjected to the data conversion; and
a gradation drive unit which performs the address scanning for changing each of the pixel cells from the lit mode to the unlit mode in accordance with the pixel data subjected to the multi-gradation processing for each of the display line groups in each of the M divided subfields.

2. A device according to claim 1, wherein subfields excluding a beginning subfield and a end subfield in one field are formed by the M divided subfields.

3. A device according to claim 1, wherein the M display line groups includes a first display line group including an [M·(k−1)+1]th display line (M is a natural number and k is a natural number equal to or smaller than n/M), a second display line group including an [M·(k−1)+2]th display line, . . . , and an Mth display line group including an [M·(k−1)+M]th display line.

4. A method for driving a display panel which has n (n is a natural number) display lines and pixel cells carrying pixels for each of the n display lines, and in order to display a halftone image in a one-field display period of a video signal which is divided into the plurality of sub-fields, for performing address scanning for changing each of the pixel cells from a lit mode to an unlit mode in one of the plurality of subfields in accordance with image data based on the video signal,
a predetermined number of continuous subfields in one field each being formed by M divided subfields and the n display lines being divided into M display line groups for each display lines,
said method comprising:
a step of applying data conversion to pixel data corresponding to each of the M display line groups with a different conversion characteristic from each other;
a step of applying multi-gradation processing to the pixel data subjected to the data conversion; and
a step of performing the address scanning for changing each of the pixel cells from the lit mode to the unlit mode in accordance with the pixel data subjected to the multi-gradation processing for each of the display line groups in each of the M divided subfields.

5. A method according to claim 4, wherein subfields excluding a beginning subfield and a end subfield in one field are formed by the M divided subfields.

6. A method according to claim 4, wherein the M display line groups includes a first display line group including an [M·(k−1)+1]th display line (M is a natural number and k is a natural number equal to or smaller than n/M), a second display line group including an [M·(k−1)+2]th display line, . . . , and an Mth display line group including an [M·(k−1)+M]th display line.

7. A device for driving a display panel which has a plurality of display lines and pixel cells carrying pixels for each of the plurality of display lines, so as to display a halftone image in accordance with image data based on the video signal,
said device comprising:
a data converting unit which applies, for each display line group including p (p is a natural number equal to or larger than two) display lines adjacent to one another, data conversion to pixel data corresponding to each of the p display lines with a different conversion characteristic from each other for each of the display lines;
a multi-gradation processing unit which applies multi-gradation processing to the pixel data subjected to the data conversion; and
a light emission driver which allows the pixel cells to emit light in accordance with the pixel data subjected to the multi-gradation processing with a luminance weight different from each other given to each of the display line groups.

8. A method for driving a display panel which has a plurality of display lines and pixel cells carrying pixels for each of the plurality of display lines, so as to display a halftone image in accordance with image data based on the video signal,
said method comprising:
a step of applying, for each display line group including p (p is a natural number equal to or larger than two) display lines adjacent to one another, data conversion to pixel data corresponding to each of the p display lines with a different conversion characteristic from each other for each of the display lines;
a step of applying multi-gradation processing to the pixel data subjected to the data conversion; and
a step of allowing the pixel cells to emit light in accordance with the pixel data subjected to the multi-gradation processing with a luminance weight different from each other given to each of the display line groups.
